(19) United States
(12) Patent Application Publication
(10) Pub. No.: US 2021/0342780 A1
(43) Pub. Date: Nov. 4, 2021

(54) INITIATING DELIVERY BY MAIL USING PRE-GENERATED BARCODE

(71) Applicant: Todd Schannuth, Irvine, CA (US)

(72) Inventor: Todd Schannuth, Irvine, CA (US)

(21) Appl. No.: 16/950,174

(22) Filed: Nov. 17, 2020

Related U.S. Application Data
(60) Provisional application No. 62/704,324, filed on May 4, 2020.

(51) Int. Cl. G06Q 10/08; G06K 7/14; G06K 7/10; G06Q 20/32; G06Q 20/40; G06F 16/23

(52) U.S. Cl. CPC G06Q 10/0838; G06K 7/1413; G06K 7/10861; G06Q 20/322; G06Q 2250/00; G06Q 20/326; G06Q 20/40; G06K 7/1417; G06F 16/23; G06Q 20/3276

(57) ABSTRACT

A system for initiating a delivery by mail may include a database storing a plurality of unique codes and a barcode reader for reading a barcode from a surface of an article to be delivered, the barcode corresponding to one of the unique codes. The system may further include a server operable to update the database in response to the reading of the barcode to associate delivery information for the article with the unique code corresponding to the barcode, the delivery information including at least a delivery address of the article.

### CROSS-REFERENCE TO RELATED APPLICATIONS

This application relates to and claims the benefit of U.S. Provisional Application No. 62/704,324, filed May 4, 2020 and entitled “Method for Purchasing Postage with Assignable Barcodes and Mobile Device with and without Security of Anonymity of Parties,” the entire contents of which is expressly incorporated herein by reference.

### STATEMENT RE: FEDERALLY SPONSORED RESEARCH/DEVELOPMENT

Not Applicable

### BACKGROUND

The current system of mailing letters and packages used by the United States Postal Service and delivery companies such as UPS and FedEx benefits from various modern technologies including barcode readers, lasers, conveyor belts, and automatic sorters. These technologies greatly speed up the delivery process once an item has been fully prepared for delivery and received behind the counter of a post office or other drop-off location. However, on the customer side of the counter, the system remains largely unchanged since the 1800s.

Typically, a sender wishing to send a package first boxes up the item to be delivered and then locates the address of the recipient (in a smartphone contacts list, for example). Using a pen, the sender then transcribes the address onto the package, along with the senders' own return address. At this point, the sender usually goes to a post office, which often requires waiting in line. At the post office, once the package is weighed and measured, the sender waits while the clerk copies the same address that the sender wrote on the package into a computer system. After answering a series of questions about the package contents (hazardous, liquid, perishable, etc.) and delivery preferences (speed of delivery, insurance, etc.), and possibly filling out customs forms for an international delivery, the sender pays the clerk (e.g. by swiping a credit card). In a typical delivery, it is only at this stage, once all of the information is in the computer, that the clerk is able to print out a mailing label with a unique barcode to place on the package. From there, the package can finally be received behind the counter and jump into 21st century automation using the available technologies. Unfortunately, the sender has typically just wasted at least 30 minutes preparing the package for delivery.

For some types of delivery (e.g. retail returns), more streamlined systems exist. A sender may, for example, designate all the necessary delivery information on a home computer and then print a mailing label herself using a printer. After affixing the mailing label to the package, the sender may drop the package off at a drop-off location. In this way, the sender may avoid spending significant time waiting for a clerk to enter the information and print the mailing label at a post office counter. However, in this case, the sender still must have access to a printer and must essentially perform the same time-consuming process of entering information, printing the mailing label, and preparing the package, the only real difference being that the sender can do so in her own home.

Whether a package is prepared for delivery at a domestic or foreign post office, UPS store, FedEx Office, Staples, or within one's home, the use of pens, pencils, printers, stamps, stickers and labels to address packages and generate unique computer-readable identifiers is time-consuming and fraught with waste of time and resources. Moreover, having sender and receiver addresses printed on envelopes and mailing labels leaves them vulnerable to bad actors, which is especially problematic in the context of secure communications by diplomats or military members, or in the case of returning voters' ballots.

### BRIEF SUMMARY

The present disclosure contemplates various systems and methods for overcoming the above drawbacks accompanying the related art. One aspect of the embodiments of the present disclosure is a system for initiating a delivery by mail. The system may comprise a database storing a plurality of unique codes and a barcode reader for reading a barcode from a surface of an article to be delivered, the barcode corresponding to one of the unique codes. The system may further comprise a server operable to update the database in response to the reading of the barcode to associate delivery information for the article with the unique code corresponding to the barcode, the delivery information including at least a delivery address of the article.

The barcode reader may comprise a smartphone. The barcode reader may comprise a camera of the smartphone.

The server may be operable to communicate with the smartphone to obtain one or more items of the delivery information. The server may be operable to communicate with the smartphone to obtain the delivery address from a contact list stored on the smartphone. The server may be operable to communicate with the smartphone to obtain an identifier associated with a user profile. The delivery information may include a return address of the article, and the server may be operable to obtain the return address from the user profile associated with the identifier. The delivery information may include a payment account to be charged for delivery of the article, and the server may be operable to obtain the payment account from the user profile associated with the identifier.

The server may be operable to communicate with the smartphone to obtain one or more items of the delivery information from user input to a user interface of a mobile application installed on the smartphone. The one or more items of the delivery information may include a weight of the article. The one or more items of the delivery information may include a physical dimension of the article.

In response to the reading of the barcode, the server may be operable to generate a payment authorization prompt on a user interface of a mobile application installed on the smartphone. The database may be updated to associate the delivery information for the article with the unique code corresponding to the barcode in response to a user interaction with the payment authorization prompt.

The database may store physical dimensions of the article or a flat rate of the article in association with at least a portion of the unique codes prior to the reading of the barcode.

The article may be a box or envelope and the barcode may be printed on the article.

The barcode may be printed on an adhesive stamp affixed to the surface of the article.

The barcode may comprise a QR code.

The server may be operable to update the database in response to a second reading of the barcode to associate new delivery information for the article with the unique code corresponding to the barcode, the new delivery information including at least a new delivery address of the article.

Another aspect of the embodiments of the present disclosure is a method of initiating a delivery by mail. The method may comprise storing a plurality of unique codes in a database and reading a barcode from a surface of an article to be delivered, the barcode corresponding to one of the unique codes. The method may further comprise updating the database in response to the reading of the barcode to associate delivery information for the article with the unique code corresponding to the barcode, the delivery information including at least a delivery address of the article.

Another aspect of the embodiments of the embodiments of the embodiments of the present disclosure is a non-transitory program storage medium on which are stored instructions executable by a processor or programmable circuit to perform operations for initiating a delivery by mail. The operations may comprise storing a plurality of unique codes in a database and receiving data obtained by reading a barcode from a surface of an article to be delivered, the barcode corresponding to one of the unique codes. The operations may further comprise updating the database in response to the receiving of the data to associate delivery information for the article with the unique code corresponding to the barcode, the delivery information including at least a delivery address of the article.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an example system for initiating a delivery by mail according to an embodiment of the present disclosure; and

FIG. 2 shows an example operational flow of the system.

### DETAILED DESCRIPTION

The present disclosure encompasses various embodiments of systems, methods, and software for initiating a delivery by mail. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

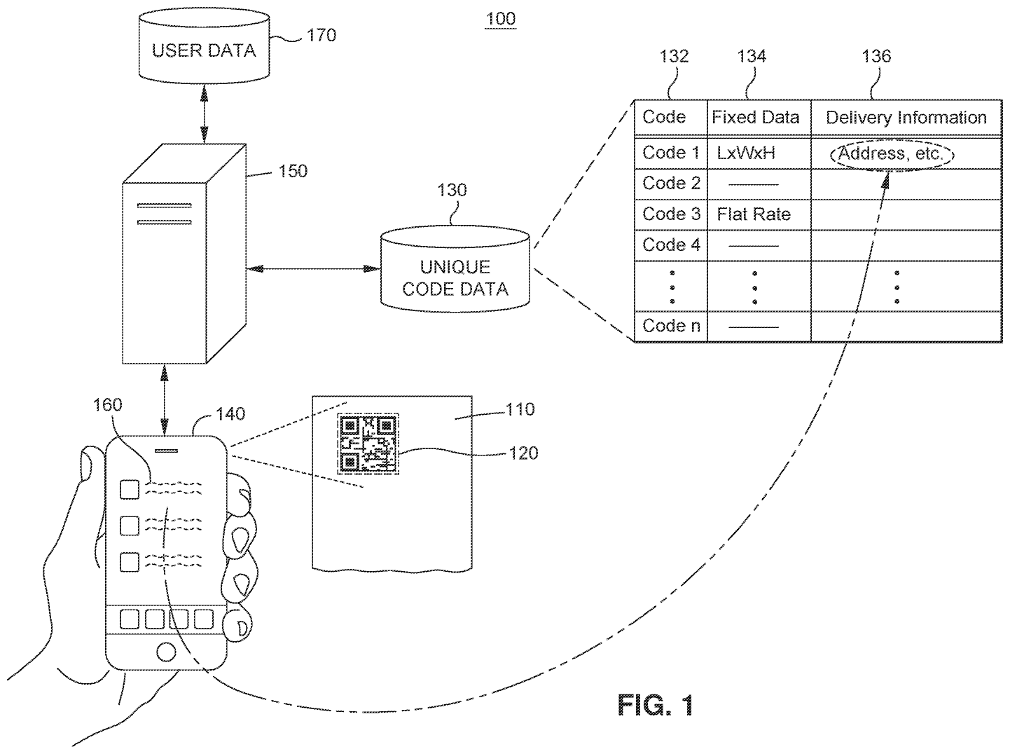

FIG. 1 shows an example system 100 according to an embodiment of the present disclosure. A person wishing to mail an envelope, postcard, box, or other article 110 may read a barcode 120 (e.g. a QR code) that is preprinted on or otherwise affixed to the article 110. In response to the reading of the barcode 120, the system 100 may associate the barcode 120 with a delivery address and/or other delivery information. The delivery information may be input using a mobile application or pulled from a user profile, for example. Unlike conventional methods of sending mail, the barcode 120 need not be pre-associated with any delivery information. Therefore, the barcode 120 may be generated and printed in advance (e.g. at the time of manufacturing the envelope or box), completely eliminating the need to generate a mailing label containing delivery information at the time of mailing. In addition, because the barcode 120 may be only a generic identifier serving as a placeholder, the barcode 120 may have no inherent value, reducing the risk of theft as compared to prepaid postage.

The system 100 may comprise a unique code database 130 storing a plurality of unique codes 132 (e.g. Code 1, Code 2, . . . Code n) from which barcodes 120 may be derived. These codes 132 may be generated in large batches (e.g. 100,000 codes) and may be long enough (e.g. 25 digits) so as not to run out of possible unique codes 132 for the foreseeable future. As an example, a shipper such as the U.S. Postal Service may request a batch of 100,000 codes 132 (or barcodes 120 derived therefrom). The provider of the system 100 may email the batch of codes 132 to the shipper, in some cases for free as they have no inherent value, while storing the same codes 132 in the unique code database 130. The shipper may then print barcodes 120 corresponding to the unique codes 132 on envelopes, boxes, etc. during their manufacture. In order to allow customers to use their own packaging, or in the case of uniquely shaped articles 110 that do not fit in standard packaging, the shipper may additionally provide adhesive stickers containing barcodes 120 to be adhered to articles 110 to be mailed. Whether it is printed on or adhered to the article 110, the barcode 120 may initially only link to a generic code 132 in the unique code database 130, without any associated delivery information.

The system 100 may further comprise a barcode reader 140 for reading the barcode 120 from the surface of the article 110 to be delivered. The barcode reader 140 may be a dedicated device or may be a general-purpose mobile device such as a smartphone with a built-in camera as illustrated in FIG. 1. Software for use with the system 100 may be installed on such a mobile device 140. For example, a mobile application (an “app”) associated with the system 100 may be available for download on an app store or other distribution platform. In order to read the barcode 120, the user of the mobile device 140 may access the built-in camera from within the mobile application (after granting any necessary permission to the application) or use a native camera application of the mobile device 140 to optically scan the barcode 120.

The system 100 may further comprise a server 150 operable to update the unique code database 130 to associate delivery information for the article 110 with the unique code 132 corresponding to the barcode 120. The association of delivery information 136 with the unique code 132 may be done in response to the reading of the barcode 120, rather than at the time of generating or printing the barcode 120, making it unnecessary to generate or print any mailing label at the time of mailing. The server 150 may include one or more processors and may be embodied in a single computer or a plurality of networked computers (e.g. a cloud network) remote from the mobile device 140. The server 150 may communicate with a web browser or mobile application of the mobile device 140 to obtain data corresponding to the read barcode 120 in order to match the barcode 120 with its corresponding unique code 132 stored in the unique code database 120. The delivery information 136 to be associated with the unique code 132 may be generated by user input to a user interface 160 of the mobile application (or web browser) installed on the mobile device 140. For example, after any necessary permission is granted to the application by the user, the mobile application may access a contact list stored on the mobile device 140 and present the contact list on the user interface 160 as shown in FIG. 1. The user may then select a contact, allowing the server 150 to obtain the delivery address (e.g. physical address, P.O. box, APO/FPO, vessel, embassy, GPS locator), the recipient name, or other item of delivery information 136 from the contact list. The user interface 160 may also allow the user to input additional delivery information 136 such as a weight of the article 110, one or more physical dimensions of the article 110 (e.g. length, width, height, thickness, girth), priority, insurance, customs information, special handling information, etc. If any requested information is unknown (e.g. if a scale is unavailable to weigh the article 110), the user may simply input “don't know.” Appropriate payment may then be automatically deducted from the user's payment account when the shipper weighs the article 110 at their facility (e.g. up to a limit specified by the user).

Certain items of delivery information 136 may be associated with a particular sender but may remain the same from delivery to delivery. In the case of the return address of the article 110, for example, it may only be necessary for the user to confirm a default selection on the mobile application, rather than inputting any information. The same may be true of the sender name, a payment account to be charged for the delivery (e.g. a credit card or bank account on file), etc. In these cases, the server 150 may communicate with the mobile device 140 to obtain an identifier associated with a user profile of the user. The identifier may be generated from login session data of the mobile application, for example. The server 150 may then locate the default delivery information 136 associated with the user profile in a user database 170 and associate such default delivery information 136 with the unique code corresponding to the barcode 120 (either automatically or after confirmation by the user). For example, in response to the reading of the barcode 120, the user interface 160 may present the user with a payment authorization prompt tied to a payment account of the user profile. The server 150 may then associate the delivery information 136 with the unique code 132 stored in the unique code database 130 in response to a user interaction with the payment authorization prompt.

In some cases, the U.S. Postal Service or other shipper may request that a batch of codes 132 be pre-designated to be associated with an envelope or box having specific dimensions and/or a specific flat rate. For example, the shipper might request a batch of 100,000 unique codes 132 for the purpose of printing barcodes 120 specifically on each of 100,000 Medium Size Flat Rate Priority Mail boxes that they are ordering from their box supplier. In this case, the provider of the system 100 may pre-associate relevant fixed data 134 (dimensions, flat rate, etc.) with these codes 132 in the unique code database 130. As shown in FIG. 1, for example, Code 1 is associated with fixed data 134 indicating the dimensions (L×W×H) of the article 110 to be mailed, and Code 3 is associated with fixed data 134 indicating a flat rate. When a person reads the barcode 120 corresponding to Code 1, the amount of delivery information 136 that needs to be entered into the mobile device 140 using the mobile application may be very little: delivery address, recipient name, and weight, for example. When a person reads the barcode 120 corresponding to Code 3, the postage may be predetermined. Therefore, the amount of delivery information 136 that needs to be entered may be even less: only the delivery address and recipient name, for example.

When a sender wishes to send a package using the disclosed system 100, the sender may pick up one of these free Priority Mail boxes having a preprinted barcode 120 and take it home. When it is time to mail the package, the sender does not need to wait in line anywhere and does not need a pen, stamp, label, printer, or ink. The sender simply pulls out her smartphone and opens the mobile application associated with the system 100. She points the phone's camera at the box and scans the QR code (barcode 120). The parcel (and information about it) is now essentially connected, via the Internet and possibly a cellular network, to the server 150, and subsequently to the post office.

The old process of entering information can now be done much more quickly and without waiting in line or the need to print or write anything. The app instantly knows that a Medium Size Flat Rate Priority Mail box from the USPS has been scanned, because that is what this specific barcode 120 was assigned to be printed on (as represented by fixed data 134 in the unique code database 130). There is no need to enter weight or dimensions because it is a Flat Rate box. There is also no need to enter a return address because the sender provided address information and a payment credit card (stored with her user profile in the user database 170) when she first downloaded the smartphone app. There is no need to type in the recipient's address since the address can be pulled from a smartphone contacts list (or an email, Paypal, eBay, etc.) with a few taps. The sender only needs to tap “pay postage” to authorize payment and the package is ready to be dropped off or picked up for delivery.

Using the system 100, it is not even necessary to write an address on the box. All the pertinent information is provided to the server 150 from the app: who the parcel is coming from, who it is going to, the fact that it is Priority Mail, its unique code 132, and the fact that postage has been paid. The provider of the system 100 immediately zips that information off via the Internet to the USPS, who is waiting for your parcel before you even leave your house. When that same barcode 120 is scanned at a USPS sorting facility, they have everything they need to sort it, track it, and deliver it.

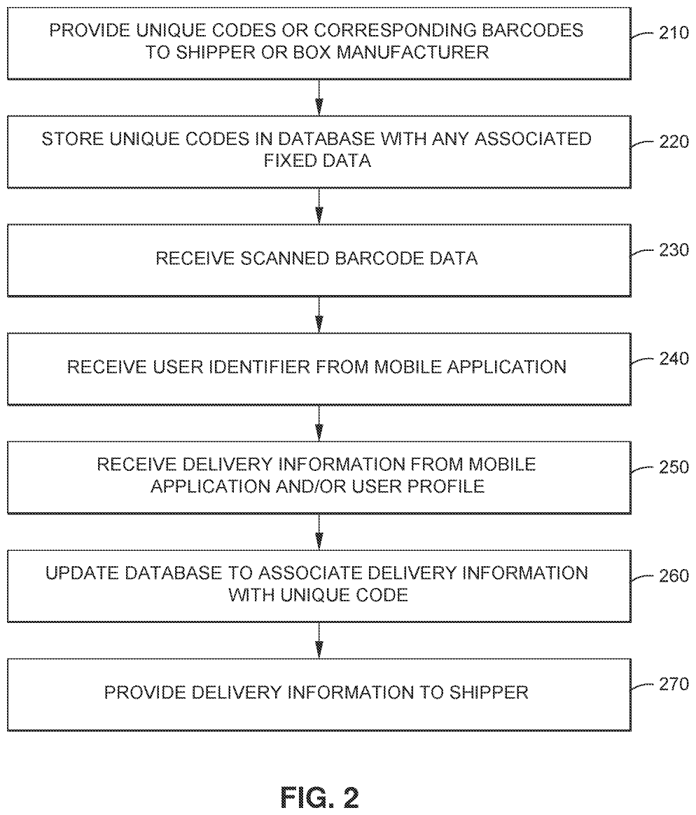

FIG. 2 shows an example operational flow of the system 100. The operational flow may begin with providing one or more batches of unique codes 132, or the corresponding barcodes 120 themselves, to a shipper such as the U.S. Postal Service or to a box or envelope manufacturer (step 210). In the above example, the USPS requested a batch of codes 132 and instructed its box supplier to print corresponding barcodes 120 on each box of an order placed with the box supplier. The unique codes 132 may be any unique identifiers such as alphanumeric codes of sufficient length to ensure uniqueness, and the barcodes 120 may be QR codes readable by smartphones or any other type of barcode and in some cases may conform to a standard currently used by the USPS such as an Intelligent Mail barcode standard (e.g. GS1-128 as defined by ISO/IEC 15417:2007). In a case where the provider of the system 100 is itself a shipper such as the USPS, providing the codes 132 in step 210 may encompass generating such codes 132 for use. Along the same lines, the provider of the system 100 may itself print adhesive stickers containing the barcodes 120, in which case step 210 may encompass the distribution of such stickers containing barcodes 120 to shippers and other businesses including retail packaging stores, drug stores, etc.

Before or after step 210, the operational flow may include storing the same unique codes 132 in a unique code database 130 along with any associated fixed data 134 (step 220). As explained above, certain information may be fixed, for example, in the structure of the particular article 110 (such as box dimensions) or by convention according to the policies of a shipper (such as a flat rate or a priority level that does not depend on weight). Such predetermined specifications for shipping an article 110 may be stored as fixed data 134 in association with the codes 132 in the unique code database 130. Other examples of fixed data 134 that may be associated with a particular envelope or box may include special handling instructions (e.g. fragile, perishable, hazardous, liquid, etc.), country code, customs or insurance information, etc. It is noted, however, that any of this information may instead be left variable to be associated with a given code 132 after scanning the barcode 120, rather than stored as fixed data 134 ahead of time. The data structure stored in the unique code database 130 is illustrated in table form for ease of understanding in order to represent associations between each code 132 and its corresponding fixed data 134 and/or delivery information 136, with a single row of the table representing the data associated with a single code 132. Actual implementation of the unique code database 130 may take various forms including, for example, a centralized or cloud-based database or a distributed ledger such as a blockchain (e.g. a permissioned blockchain).

With the unique codes 132 and any fixed data 134 stored in the unique code database 130, the corresponding barcodes 120 may be widely distributed to customers of the USPS or other shippers as well as to retail customers in the form of envelopes and boxes with preprinted barcodes 120 and/or rolls or sheets of stickers containing barcodes 120. When such a customer wants to mail something, she may pack the item to be mailed in an envelope, box, or other article 110 having a preprinted barcode 120 or apply a sticker containing a barcode 120 to an envelope, box, or other article 110 that doesn't have one. In some cases, the article 110 may not be a package for the item at all and may be the item itself to be shipped without packaging. In the case of a postcard, magazine, or other ready-to-mail document, the barcode 120 may be printed on the document using Photoshop, Microsoft Word, Salesforce, Wordpress, or other document production or word processing software integrated with the system 100 via an API or plugin, for example. In other cases, a sticker containing the barcode 120 may be the only choice. Whatever the article 110, the sender may simply scan the barcode 120 using a mobile device such as a smart phone or other barcode reader 140. The operational flow of FIG. 2 may then continue with the server 150 receiving the scanned barcode data from the barcode reader 140 (step 230).

In order for the sender of the article 110 to designate delivery information 136 such as a delivery address of the article 110, she may input such information using a mobile application or website contemporaneously with (e.g. before or after) scanning the barcode 120. During this process, the server 150 may receive a user identifier derived from login session data taken from the mobile application or website (step 240). As the user inputs a delivery address, recipient, weight, etc. as necessary for sending the particular article 110 into a user interface of the mobile application or webpage, the server 150 may reference a user database 170 to pull a user profile associated with the identifier. In this way, the server 150 may receive delivery information 136 from the user interface entry and/or from the user profile (step 250). For example, the delivery information 136 may include a delivery address taken from a contact list stored on a mobile device serving as the barcode reader 140 as well as a return address and payment information stored in the user database 170 (with confirmation of payment having been made by the user on the user interface of the mobile application). The server may then update the unique code database 130 to associate the delivery information 136 with the unique code 132 corresponding to the scanned barcode 120.

Lastly, in a case where the provider of the system 100 is not the shipper, the operational flow of FIG. 2 may conclude with providing the delivery information 136, including confirmation of payment by the sender, to the USPS or other shipper (step 270). The delivery information 136 can be provided to the shipper in response to the scanning of the same barcode 120 by the shipper at initial pick-up of the article 110 from a mailbox or drop-off location. Additionally, the delivery information 136 may have been provided earlier, e.g. in response to the sender's original scan of the barcode 120, in order to provide notice to the shipper so that the shipper can be expecting the article 110 to be placed in the mailbox or at the drop-off location. Once the shipper has received the article 110 and the delivery information 136 associated with the barcode 120, the shipper may confirm that any payment information is sufficient for the article 110 and immediately begin delivery of the article 110 to the delivery address indicated in the delivery information 136. The same delivery information 136 may be provided by the server 150 to the shipper upon subsequent scans of the barcode 120 in order to allow for tracking of the article 110 at sorting facilities. In this regard, it is noted that the shipper's account may have greater privileges than a customer account (e.g. as determined by a shipper's login credentials), granting the shipper access to detailed delivery information with each scan while an ordinary customer's scan of a barcode 120 may maintain anonymity of the sender and recipient while the article 110 is en route. Alternatively, or additionally, the shipper may update its own databases to reflect the shipping information 136 and to associate the shipping information 136 with its own barcodes or other identifiers (e.g. an Intelligent Mail barcode).

In the event that the payment information associated with the unique code 132 is insufficient for the delivery of the article 110, for example, if the actual weight or size of the article 110 is greater than the weight or size that was measured by the sender and used to calculate the sender's payment (or if the sender didn't know the weight or size and indicated “don't know” in the mobile application), there may be additional postage due. Unlike conventional methods, where the article 110 would be returned to the sender, the shipper may simply charge the appropriate amount to the sender's payment account at the time of scanning the barcode 120 when picking up the article 110 from a drop-off location or at a sorting facility. It is also contemplated that the sender may set a dollar limit not to be exceeded when additional postage is due in this way, in which case the sender may be notified in the mobile application and given the option to confirm payment, to lower the cost of the delivery (e.g. by lowing priority), or to retrieve the item.

In the interest of conserving resources and reducing waste for the benefit of the environment, it is contemplated that a given barcode 120 and its corresponding unique code 132 may be used more than once. For example, in the case of an article 110 in the form of a box having a barcode 120 that was printed on the box at the time of manufacturing, the box and barcode 120 may remain in good condition after a single delivery. This is especially true because, owing to the disclosed system 100, it may be unnecessary to apply mailing labels and other adhesive stickers whose removal and replacement would otherwise have a tendency to damage the box. Therefore, once the article 110 has been finally delivered to its recipient, the final scan of the barcode 120 at its delivery point (or a subsequent scan by the recipient) may effectively “erase” the delivery information 136 associated with the corresponding unique code 132 from the unique code database 130, making the barcode 120 and corresponding unique code 132 reusable for a subsequent unrelated delivery. For record-keeping purposes, the data need not actually be erased. The delivery information 136 of the completed delivery can simply be flagged in the unique code database 130 as completed or closed, causing subsequent scans of the barcode 120 to link to a new data location (e.g. a second delivery information column in the example table of FIG. 1). The recipient can therefore reuse the box for her own mailing simply by scanning the same barcode 120 (repeating steps 230 through 270 with new delivery information 136, a new user identifier/profile, etc.).

Along the same lines, an article 110 that is en route may be seamlessly rerouted using the system 100 simply by changing the delivery information 136 stored in the unique code database 130. For example, upon finding out that the intended recipient of an article 110 is traveling to a trade show, the sender of the article 110 may use the mobile application or website associated with the system 100 to change the delivery address of a “parcel in transit” to the recipient's hotel or tradeshow (e.g. locating the recipient using GPS data or the recipient's phone number, which may be dialed by the app without revealing the actual phone number to the delivery person). Any additional fee for rerouting the article 110 may be paid for using the same mobile application or website using payment information on file as described above. It should be noted that the system 100 can easily tell whether it is the sender attempting to reroute the article 110 or some nefarious third party because the sender's information (e.g. login identifier, user profile, etc.) may be included in the delivery information 136 associated with the unique code 132 stored in the unique code database 130.

When the recipient receives the article 110, the barcode 120 may also be used to enhance the security of the delivery and ensure the correct recipient. For example, when a delivery person scans the barcode 120 at the point of delivery, the server 150 may transmit a passcode (e.g. a 4-digit number) to the recipient by email or text message using the information of the recipient stored in association with the unique code 132. The recipient may be required to input the passcode into a device held by the delivery person, or to tell the delivery person the passcode, or in some cases to unlock a locker containing the article 110 using the passcode as a key, prior to receiving possession of the article 110. In this way, the system 100 may be used to implement two-factor authentication. Analogously, two-factor authentication may be required to confirm the identity of the sender when sending the article 110.

In the above examples, a barcode 120 such as a QR code is printed or otherwise provided (e.g. by adhesive sticker) on the article 110, where the reading of the barcode 120 identifies a unique code 132 stored in the unique code database 130. However, the disclosure is not intended to be so limited. For example, the system 100 may use RFID and/or NFC technology in place of barcode technology or in addition to barcode technology (e.g. as in the case of a smart label). An active or passive RFID tag may be provided on the article 110, which may be read by an RFID reader (e.g. the same smartphone that may be used as the barcode reader 140) to identify the corresponding unique code 132. Similarly, a unique hand-written signature, unique characteristics derived from a photo of the package, or even a hand-drawn scribble could be used as alternate unique identifiers, distinguishable by smartphone software.

The functionality described above in relation to the components of the system 100 shown in FIG. 1 and the operational flow described in relation to FIG. 2 may be wholly or partly embodied in one or more computers including a processor (e.g. a CPU), a system memory (e.g. RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g. over the Internet), such as the mobile device 140 accessing the various user interfaces described throughout this disclosure via a mobile application or web browser.

It is also contemplated that the disclosed system 100 can be used to track items for physical and information security generally, even outside the shipping context described above. For example, the system 100 may be used for tracking the movement and history of items in the context of inventory control, metadata association, election ballot security, cashless payments for items and invoices, and theft deterrence. Depending on the context, the delivery information 136 shown in FIG. 1 may be replaced by other relevant data to be stored in association with the pre-generated code 130 at the time of scanning the barcode 120, such as voting selections (with or without mailing information) in the case of the article 110 being an election ballot. Along the same lines, the delivery information 136 may be replaced by pricing data to be stored in association with the pre-generated code 130 at the time of scanning the barcode 120, such as a retail price in the case of a cashless payment for the unique article 110 that the barcode 120 appears on. For the purposes of tracking the movement and history of a historical museum piece, medical specimen, piece of fine art, the delivery information 136 may be replaced or supplemented by a long narrative history of article 110, for example. In all of these contexts, the information 136 may point to ownership of the article 110 for the sake of theft-deterrence and inventory control.

The computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for initiating a delivery by mail, the system comprising:
a database storing a plurality of unique codes;
a barcode reader for reading a barcode from a surface of an article to be delivered, the barcode corresponding to one of the unique codes; and
a server operable to update the database in response to the reading of the barcode to associate delivery information for the article with the unique code corresponding to the barcode, the delivery information including at least a delivery address of the article.

2. The system of claim 1, wherein the barcode reader comprises a smartphone.

3. The system of claim 2, wherein the server is operable to communicate with the smartphone to obtain one or more items of the delivery information.

4. The system of claim 2, wherein the server is operable to communicate with the smartphone to obtain the delivery address from a contact list stored on the smartphone.

5. The system of claim 2, wherein the server is operable to communicate with the smartphone to obtain an identifier associated with a user profile.

6. The system of claim 5, wherein the delivery information includes a return address of the article, and the server is operable to obtain the return address from the user profile associated with the identifier.

7. The system of claim 5, wherein the delivery information includes a payment account to be charged for delivery of the article, and the server is operable to obtain the payment account from the user profile associated with the identifier.

8. The system of claim 2, wherein the server is operable to communicate with the smartphone to obtain one or more items of the delivery information from user input to a user interface of a mobile application installed on the smartphone.

9. The system of claim 8, wherein the one or more items of the delivery information includes a weight of the article.

10. The system of claim 8, wherein the one or more items of the delivery information includes a physical dimension of the article.

11. The system of claim 2, wherein, in response to the reading of the barcode, the server is operable to generate a payment authorization prompt on a user interface of a mobile application installed on the smartphone, the database being updated to associate the delivery information for the article with the unique code corresponding to the barcode in response to a user interaction with the payment authorization prompt.

12. The system of claim 2, wherein the barcode reader comprises a camera of the smartphone.

13. The system of claim 1, wherein the database stores physical dimensions of the article in association with at least a portion of the unique codes prior to the reading of the barcode.

14. The system of claim 1, wherein the database stores a flat rate of the article in association with at least a portion of the unique codes prior to the reading of the barcode.

15. The system of claim 1, wherein the article is a box or envelope and the barcode is printed on the article.

16. The system of claim 1, wherein the barcode is printed on an adhesive stamp affixed to the surface of the article.

17. The system of claim 1, wherein the barcode comprises a QR code.

18. The system of claim 1, wherein the server is operable to update the database in response to a second reading of the barcode to associate new delivery information for the article with the unique code corresponding to the barcode, the new delivery information including at least a new delivery address of the article.

19. A method of initiating a delivery by mail, the method comprising:
storing a plurality of unique codes in a database;
reading a barcode from a surface of an article to be delivered, the barcode corresponding to one of the unique codes; and
updating the database in response to the reading of the barcode to associate delivery information for the article with the unique code corresponding to the barcode, the delivery information including at least a delivery address of the article.

20. A non-transitory program storage medium on which are stored instructions executable by a processor or programmable circuit to perform operations for initiating a delivery by mail, the operations comprising:
storing a plurality of unique codes in a database;
receiving data obtained by reading a barcode from a surface of an article to be delivered, the barcode corresponding to one of the unique codes; and
updating the database in response to the receiving of the data to associate delivery information for the article with the unique code corresponding to the barcode, the delivery information including at least a delivery address of the article.
